(19) United States
(12) Patent Application Publication
(10) Pub. No.: US 2009/0018040 A1
(43) Pub. Date: Jan. 15, 2009

(54) Dispersants from Condensed Polyamines

(75) Inventors: Renee A. Eveland, Concord Township, OH (US); Matthew D. Gieselman, Willoughby Hills, OH (US); Douglas M. Barr, Hudson, OH (US); Gregory R. McCullough, Eastlake, OH (US); John K. Pudelski, Cleveland Heights, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: THE LUBRIZOL CORPORATION, Wickliffe, OH (US)

(21) Appl. No.: 11/815,407

(22) PCT Filed: Feb. 3, 2006
(86) PCT No.: PCT/US06/03856

§ 371 Date: Apr. 29, 2008

Related U.S. Application Data
(60) Provisional application No. 60/649,862, filed on Feb. 3, 2005.

(51) Int. Cl. C10M 133/06; C08G 73/02

(52) U.S. Cl. 508/551; 528/422; 528/367; 508/558

(57) ABSTRACT

A succinimide dispersant comprising the condensation product of a hydrocarbyl-substituted succinic anhydride or reactive equivalent thereof with an alkylene polyamine, wherein the alkylene polyamine is a condensed amine, exhibits improved viscometrics.

Priority is claimed from U.S. Provisional 60/649,862 filed Feb. 3, 2005.

### BACKGROUND OF THE INVENTION

The present invention relates to dispersants prepared from certain polyamines, in particular those prepared by condensation of amines using a route which is not based on ethylene dichloride as a reactant. The dispersants are useful in engine and transmission lubricants and other applications in transportation and industry.

Dispersants which are useful in lubricants, fuels, and other industrial applications are very well known materials. Dispersants frequently comprise a non-polar moiety and a polar moiety, often based on a polyamine. The polyamine portion of the dispersant helps to attract the dispersant molecule to polar contaminants within lubricating compositions and engines. One major function of a dispersant is to disperse contaminants, including soot and sludge that can form in a lubricating oil and prevent these contaminants from depositing on engine parts and contributing to oil thickening. Among commonly used dispersants are succinated polyisobutylenes (i.e., polyisobutylene-succinic anhydride, “PIBSA”) condensed with polyethyleneamines which have an average of 6-7 nitrogen atoms, such as those sold under the trade names HPA-X and E-100. Such dispersants exhibit good performance both as sludge and soot dispersants in passenger car engines, heavy duty diesel engines and several other applications.

Polyethyleneamines are commercially manufactured using two different processes, the ethylene dichloride (EDC) process and the reductive amination (RA) process. The EDC process uses ethylene dichloride and ammonia as starting materials for production of a range of polyethylene amine products of varying molecular weights. Fractional distillation is used to separate the products. The process produces several pounds of salt waste per pound of polyamine product and the yield of polyethylene amine bottoms (commonly used in dispersants) is typically only 10-25%. The RA process uses ethylene oxide and ammonia as starting materials. The main products are ethylene diamine (EDA) and diethylenetriamine (DETA) with water as a byproduct. The RA process potentially produces less waste and a more benign byproduct, but does not produce higher molecular weight polyethylene amines.

Higher molecular weight polyethyleneamines are sometimes considered more desirable than lower molecular weight polyethyleneamines for dispersant synthesis. Although higher molecular weight polyamines are produced when the EDC process is practiced, these desirable products are not produced when the RA process is practiced. Higher molecular weight polyamines can be synthesized from the products of the RA process by coupling the low molecular weight products using difunctional or multifunctional coupling materials. For example DETA, produced from either the RA process or the EDC process, can be coupled with, e.g., malonates, to form a higher molecular weight polyamine that can serve as a raw material for dispersant synthesis.

Certain PIBSA dispersants that impart greater high temperature viscosity increase to a blended oil, without undue viscosity increase at lower temperature, have well established fuel economy benefits. This characteristic of the dispersants is often referred to as “thickening power.” Greater thickening power of the dispersant allows for the use of less olefin copolymer-based viscosity modifier in the oil. “Thicker” dispersants can therefore also result in more shear-stable blends. For these reasons, recent research has focused on making dispersants with greater thickening power, which most often manifests itself in the dispersant as higher viscosity. The present invention provides a composition and process for preparing dispersants from a class of coupled polyamines, whereby the coupling process makes use of smaller polyethyleneamines from a reductive amination process and a small coupling molecule. Other small amine and polyamine starting materials are also within the scope of the invention. The new polyamines yield dispersants with excellent thickening power, compared to conventional dispersants.

U.S. Pat. No. 6,821,307, Capriotti et al, Nov. 23, 2004 (US Application 2003/01292233, Oct. 16, 2003) discloses improved fuel oil composition comprising fuel oil and certain acylated polyalkylene polyamines. The polyamine component can contain greater than 35% by weight of polyamines having more than 6 nitrogen atoms per molecule.

U.S. Pat. No. 5,854,186, Cusumano et al., Dec. 29, 1998, discloses a Koch functionalized product which is the reaction product of a hydro-carbon with carbon monoxide and a nucleophilic trapping agent, derivatized with a heavy polyamine. The heavy polyamine can be a mixture of polyamines comprising small amounts of lower polyamine oligomers such as tetraethylene pentamine and pentahexamine but primarily oligomers with more than 6 nitrogens and more extensive branching.

U.S. Pat. No. 5,792,730, Gutierrez et al., Aug. 11, 1998, discloses a succinimide dispersant which is the reaction product of hydrocarbons functionalized by halogenation, thermal “ene” reaction, or free radical grafting, and derivatized with a heavy polyamine. The heavy amine is primarily oligomers with 7 or more nitrogens, 2 or more primary amines per molecule, and extensive branching.

U.S. Pat. No. 5,783,735, Emert et al., Jul. 21, 1998, discloses a process for preparing polymeric amides by reacting a functionalized hydrocarbon polymer with a heavy polyamine to form a partially derivatized product in which at least about 85% of the functional groups are converted to heavy (thio)amide groups, and subsequently reacting with a light amine.

U.S. Pat. No. 5,580,484, Gutierrez, Dec. 3, 1996, discloses dispersants comprising hydroxy aromatic succinimide Mannich Base condensates of heavy polyamine.

U.S. Pat. No. 4,171,466, Korosec, Dec. 15, 1992, discloses oil-soluble dispersants formed by reacting certain aliphatic hydrocarbyl substituted succinic acylating agent with a mixture of hydrocarbyl polyamines containing a mixture of cyclic and acyclic alkylene polyamines.

The use of various other heavy polyamines in dispersants is also known and is taught in such patents as U.S. Pat. No. 5,756,431, U.S. Pat. No. 5,854,186, U.S. Pat. No. 5,872,084, and U.S. Pat. No. 5,565,128.

Coupling of or condensing amines such as HPA-X with materials such as 2-amino-2-hydroxymethyl-1,3-propanediol (trihydroxyaminomethane, “THAM”) using, for instance a phosphoric acid catalyst, and subsequent dispersant preparation, is known and is disclosed in such patents as U.S. Pat. No. 5,160,648, U.S. Pat. No. 5,230,714, U.S. Pat. No. 5,053,152, U.S. Pat. No. 5,296,154, and U.S. Pat. No. 5,368,615. See also, for instance, U.S. Pat. No. 5,202,489, Doumaux, Jr., et al., Apr. 13, 1993, which discloses a process for making amines by the intramolecular condensation of an amino compound to an amine having a lower molecular weight or the intermolecular condensation of an amino compound with one or more of another amine compound, using a Group IV B metal oxide condensation catalyst.

Alkylene polyamines have conventionally been made by a route from ethylene dichloride, the so-called “EDC process.” This process is described in greater detail in U.S. Pat. No. 3,462,493. Preparation of polyamines by this process may lead to small amounts of residual chlorine in the product, which is sometimes considered to be environmentally objectionable.

A problem solved by the present invention is to increase the viscosity and thickening power of dispersant in order to improve blended oil characteristics and in particular to improve fuel economy of an engine lubricated with such an oil. Other problem to be solved include improving seal performance in engines which are lubricated with oils containing dispersants. Surprisingly, it has been found that, in one embodiment, effective dispersants can be prepared from alkylene polyamines with unusually high amounts of “light” polyamine component (e.g., 4 or 5 N atoms) if the alkylene polyamine is, for instance, the catalyzed reaction or condensation product of an alkylene polyamine with a dialkanolamine.

### SUMMARY OF THE INVENTION

The present invention provides a dispersant comprising the condensation product of a hydrocarbyl-substituted moiety capable of condensing with an amine, said amine comprising a coupled polyamine which is the coupled product of an alkylene polyamine with a reactive difunctional molecule other than ethylene dichloride.

Thus, in certain embodiments the present invention provides a succinimide dispersant comprising the condensation product of a hydrocarbyl-substituted acylating agent with an alkylene polyamine, wherein the alkylene polyamine is a condensed amine prepared from materials other than ethylene dichloride. As otherwise described, the alkylene polyamine is the catalyzed reaction or condensation product of an alkylene polyamine with a dialkanolamine. As otherwise described, the alkylene polyamine is an ethylene amine reacted with a coupling agent.

The present invention further provides lubricant compositions comprising an oil of lubricating viscosity and an amount of the above-described dispersant, such as a succinimide dispersant, suitable to provide dispersancy properties thereto.

The invention further provides a method for preparing a dispersant, comprising reacting a hydrocarbyl-substituted succinic anhydride with an amine, said amine comprising a coupled polyamine which is the coupled product of an alkylene polyamine with a reactive difunctional molecule other than ethylene dichloride, under condensing conditions.

### DETAILED DESCRIPTION OF THE INVENTION

Various preferred features and embodiments will be described below by way of non-limiting illustration.

A variety of difunctional molecules can be used to couple ethyleneamines to form higher molecular weight polyamines. Illustrative molecules of this type are shown as structures Ia, Ib, Ic, and Id and include epihalohydrins (Ia) such as epichlorohydrin, maleates (Ib) such as diethylmaleate, α-halogenated acids or esters (Ic) such as ethylchloroacetate, and malonates (Id) such as diethylmalonate.

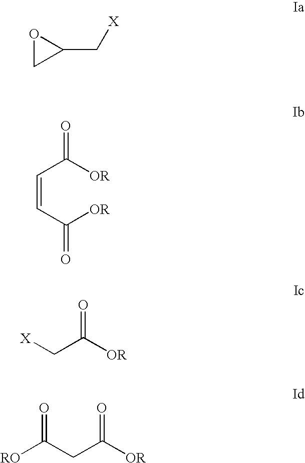

where X is a halogen and the Rs can be the same or different H or hydrocarbyl groups. Low molecular weight polyamines, such as ethyleneamines, can be reacted with these multifunctional molecules to create higher molecular weight ethyleneamines. Examples of low molecular weight alkyleneamines used as raw materials with the above coupling molecules include diethylenetriamine (DETA, an N₃ species), triethylenetetramine (TETA, N₄), ethylene diamine (EDA, N₂) and propylenediamine (PDA). The resulting coupled polyamines can be reacted with an appropriate acylating agent, for instance, polyisobutylene succinic anhydride, to form dispersants.

Epichlorohydrin (EPI), Ia, can react with two equivalents of DETA, as shown in the scheme below. Although the primary nitrogens are shown to be the reactive sites for coupling, the secondary nitrogen in DETA can also be a nucleophilic site for reaction. The polyamine product in the scheme below can undergo further reactions with epichlorohydrin to produce higher molecular weight species as well. Epichlorohydrin can be used as a coupling agent in reactions with DETA, TETA and PDA, among others.

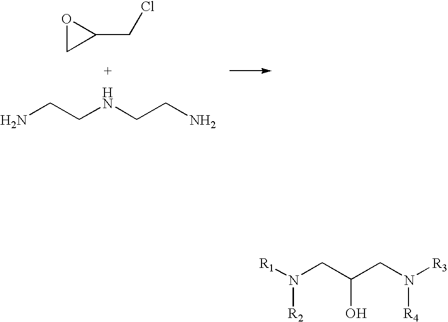

(where R₁, R₂, R₃, and R₄ are the same or different and are H or alkyleneamine or cyclic alkyleneamine.)

Diethylmaleate, Ib, can react with two or three equivalents of DETA. DETA or TETA (among others) can be coupled with diethylmaleate. See the scheme below.

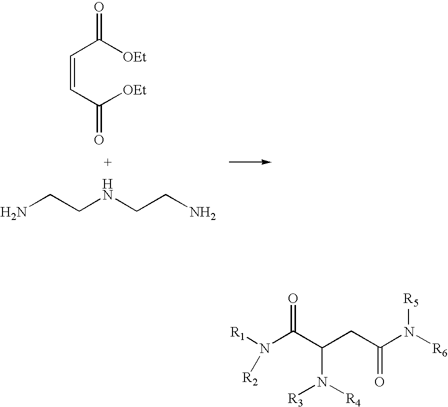

(where R1, R2, R3, R4, R5, and R6 are the same or different and are H or alkyleneamine or cyclic alkyleneamine.)

Ethylchloroacetate, Ic, can react with two equivalents of DETA. TETA can also be coupled with ethylchloroacetate.

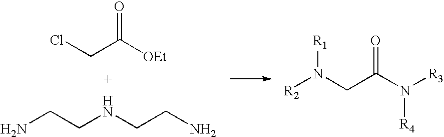

(where R1, R2, R3, and R4 can be the same or different and are H or alkyleneamine or cyclic alkyleneamine.)

Diethylmalonate, Id, can react with two equivalents of DETA. Two amide bonds can form displacing two molecules of ethanol. Intramolecular cyclization is also possible. TETA can also be coupled with diethylmalonate.

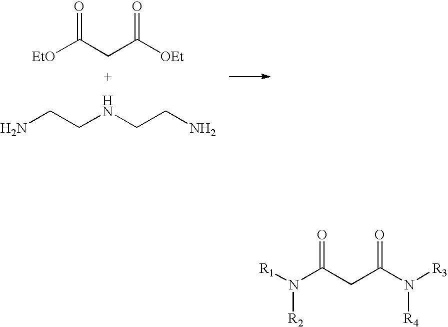

(where R1, R2, R3, and R4 are the same or different and can be H or alkyleneamine or cyclic alkyleneamine.)

The polyamine coupling can also be accomplished, for instance, with an alkanolamines such as ethanolamine and a relatively small or low molecular weight ethyleneamine, containing, for example, 2, 3, or 4 nitrogen atoms. The reaction below illustrates coupling of DETA (1) with diethanolamine (2) to give mixture of coupled amines.

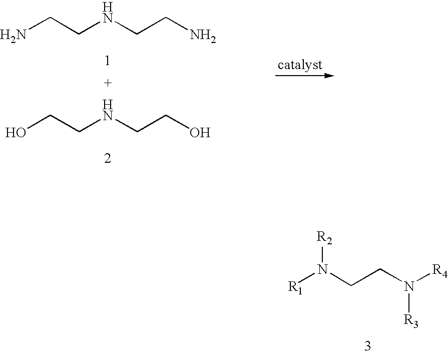

In the coupling product, 3, R₁, R₂, R₃ and R₄ can be the same or different and can represent H or alkyleneamine or cyclic alkyleneamine groups. One example of a catalyst system that can be used in such a coupling reaction is a supported zirconium dioxide. The product of a coupling reaction may be, if desired stripped of residual low molecular weight amines (e.g., those having three or fewer nitrogen atoms). This catalyst system and details of conducting the coupling or condensation reaction are disclosed in greater detail in U.S. Pat. No. 5,202,489, referred to above.

Coupled materials of this general type are also available from The Dow Chemical Company, prepared by a catalyst system and coupling process that is believed to be proprietary to The Dow Chemical Company. Suitable condensed polyamines, from The Dow Chemical Company, are believed to have a weight percent nitrogen of 29 to 35%, for example, 30% to 32%; 5.7 to 7.4, or 6.0 to 7.0 milliequivalents of primary amine functionality per gram or, alternatively expressed, 134 to 174, or 144 to 164 grams per equivalent of primary amine; and 27-35% (on a number average basis, calculated by ¹³C NMR) of primary nitrogens, 45-52% secondary nitrogens, and 16-27% tertiary nitrogens. Such suitable condensed polyamines are believed to contain 1.0-3.0 percent of N₄ species (or in one embodiment 2.3-2.8%); 10-22 percent N₅ species (or in one embodiment, 12-16%); 14-30 percent N₆ species (or in one embodiment 18-22%); 14-45 percent N₇ species (or in one embodiment 16-18%) and 8-35 percent species greater than N₇ (or in one embodiment 25-30%). Such polyamine compositions may typically also contain a certain fraction of hydroxy-containing materials, for example, 10 or 13 to 30, or 15 to 25, percent of the molecules containing at least one OH group, as calculated on the basis of GC/mass spectroscopy. In one embodiment, the amines may contain 2.9% N₄, 14% N₅, 20% N₆, 17% N₇, and 27.5%>N₇, with 18.6% hydroxy-containing material.

In another embodiment of the present invention, the coupled amines as described above can be mixed with smaller polyamines such as EDA, DETA and TETA, and the resulting mixtures used as the amine component in preparing dispersants. Yet another embodiment includes mixing the coupled amines with current EDC-produced ethylenepolyamine bottoms (such as the above-mentioned HPA-X or E-100. The various types of amines may be mixed prior to reaction with the acylating agent (such as PIBSA), or dispersants prepared from different types of amines may be mixed together.

Dispersants can be prepared from the above described polyamines or polyamine mixtures by known methods. Dispersants are well known in the field of lubricants and include primarily what is known as ashless-type dispersants and polymeric dispersants. Ashless type dispersants are characterized by a polar group attached to a relatively high molecular weight hydrocarbon chain. Typical ashless dispersants include N-substituted long chain alkenyl succinimides, having a variety of chemical structures including typically

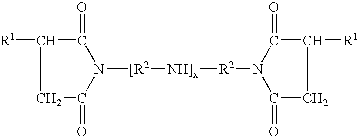

where each R¹ is independently an alkyl or a hydrocarbyl group, frequently a polyisobutyl group with a molecular weight of 500-5000, and R² are alkylene groups, commonly ethylene (C₂H₄) groups, the entire portion >N—[R²NH]ₓR²—N<representing, for the purposes of the present invention, the polyamines and mixtures thereof described hereinabove without intending to assert anything about their structure, which may normally be more complicated that that shown. Such dispersant molecules will be derived from reaction of a hydrocarbyl-substituted acylating agent (e.g., a hydrocarbyl substituted succinic anhydride or a reactive equivalent thereof such as an acid, ester, or acid halide) with the condensed polyamines described above, and a wide variety of linkages between the two moieties is possible beside the simple imide structure shown above, including a variety of amides and quaternary ammonium salts. Also, multiple succinimide groups may be attached to each R¹ group by any of a variety of linkages. Succinimide dispersants are more fully described in U.S. Pat. Nos. 4,234,435 and 3,172,892.

Another class of ashless dispersant is Mannich bases. These are materials which are formed by the condensation of a higher molecular weight, alkyl substituted phenol, an alkylene polyamine, and an aldehyde such as formaldehyde. Such materials may have the general structure

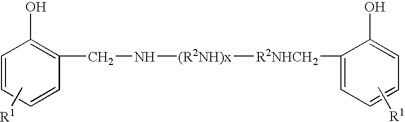

(including a variety of isomers and the like) and are described in more detail in U.S. Pat. No. 3,634,515. Again, the central portion shown in the above structure is intended to represent, for the purposes of the present invention, the polyamines described herein without intending to assert anything about their structure. R¹ is generally as described for the succinimide dispersants, above. Other dispersants include polymeric dispersant additives, which are generally hydrocarbon-based polymers which contain polar functionality, which can be based upon the polyamines described herein, to impart dispersancy characteristics to the polymer.

Dispersants can also be post-treated by reaction with any of a variety of agents. Among these are urea, thiourea, dimercaptothiadiazoles, carbon disulfide, aldehydes, ketones, carboxylic acids, hydrocarbon-substituted succinic anhydrides, nitrites, epoxides, alkaline earth metal salts, boron compounds, and phosphorus compounds. References detailing such treatment are listed in U.S. Pat. No. 4,654,403.

The dispersants of the present invention are particularly useful as a component in lubricants for transportation and industry, for example, gear oils, transmission fluids, and engine (crankcase) oils for gasoline or diesel powered engines, engines powered with alternative fuels including alcohols and alcohol/hydrocarbon mixtures, stationary gas engines, small engines including two-stroke cycle engines, as well as four-stroke cycle engines. The engines may be equipped with exhaust gas recirculation. Focusing for the moment on fully formulated engine oils, such materials will typically contain 0.5 to 10 percent by weight, or 1 to 8 percent by weight, or 3 to 7 percent by weight of dispersant. The amount in a concentrate will be correspondingly increased, to, e.g., 5 to 80 weight percent (each calculated on a diluent-free basis).

The dispersants of the present invention are typically employed in an oil of lubricating viscosity, also referred to as a base oil. The base oil used in the inventive lubricating oil composition may be selected from any of the base oils in Groups I-V as specified in the American Petroleum Institute (API) Base Oil Interchangeability Guidelines. The five base oil groups are as follows:

| | | | |
|---|---|---|---|
| Base Oil | | | Viscosity |
| Category | Sulfur (%) | Saturates (%) | Index |

| | | | | |
|---|---|---|---|---|
| Group I | >0.03 | and/or | <90 | 80 to 120 |
| Group II | <0.03 | and | >90 | 80 to 120 |
| Group III | <0.03 | and | >90 | >120 |

| | |
|---|---|
| Group IV | All polyalphaolefins (PAOs) |
| Group V | All others not included in Groups I, II, III or IV |

Groups I, II and III are mineral oil base stocks. The oil of lubricating viscosity, then, can include natural or synthetic lubricating oils and mixtures thereof. Mixture of mineral oil and synthetic oils, particularly polyalphaolefin oils and polyester oils, are often used.

Natural oils include animal oils and vegetable oils (e.g. castor oil, lard oil and other vegetable acid esters) as well as mineral lubricating oils such as liquid petroleum oils and solvent-treated or acid treated mineral lubricating oils of the paraffinic, naphthenic or mixed paraffinic-naphthenic types. Hydrotreated or hydrocracked oils are included within the scope of useful oils of lubricating viscosity.

Oils of lubricating viscosity derived from coal or shale are also useful. Synthetic lubricating oils include hydrocarbon oils and halosubstituted hydrocarbon oils such as polymerized and interpolymerized olefins and mixtures thereof, alkylbenzenes, polyphenyl, (e.g., biphenyls, terphenyls, and alkylated polyphenyls), alkylated diphenyl ethers and alkylated diphenyl sulfides and their derivatives, analogs and homologues thereof.

Alkylene oxide polymers and interpolymers and derivatives thereof, and those where terminal hydroxyl groups have been modified by, for example, esterification or etherification, constitute other classes of known synthetic lubricating oils that can be used.

Another suitable class of synthetic lubricating oils that can be used comprises the esters of dicarboxylic acids and those made from C5 to C12 monocarboxylic acids and polyols or polyol ethers. Other synthetic lubricating oils include liquid esters of phosphorus-containing acids, polymeric tetrahydrofurans, silicon-based oils such as the poly-alkyl-, polyaryl-, polyalkoxy-, or polyaryloxy-siloxane oils, and silicate oils.

Hydrotreated naphthenic oils are also known and can be used, as well as oils prepared by a Fischer-Tropsch gas-to-liquid synthetic procedure followed by hydroisomerization.

Unrefined, refined and rerefined oils, either natural or synthetic (as well as mixtures of two or more of any of these) of the type disclosed herein-above can used in the compositions of the present invention. Unrefined oils are those obtained directly from a natural or synthetic source without further purification treatment. Refined oils are similar to the unrefined oils except they have been further treated in one or more purification steps to improve one or more properties. Rerefined oils are obtained by processes similar to those used to obtain refined oils applied to refined oils which have been already used in service. Such rerefined oils often are additionally processed by techniques directed to removal of spent additives and oil breakdown products.

Engine oils and other lubricating oils will typically also contain a variety of additional additives and components that are well known to those skilled in the art. The use of such additives is optional and the presence thereof in the compositions of this invention will depend on the particular use and level of performance required. Thus the other additive may be included or excluded. The compositions may comprise a metal salt, frequently a zinc salt of a dithiophosphoric acid. Zinc salts of dithiophosphoric acids are often referred to as zinc dithiophosphates or zinc O,O′-dihydrocarbyl dithiophosphates and are sometimes referred to by the abbreviations ZDP, ZDDP, or ZDTP. One or more zinc salts of dithiophosphoric acids may be present in a minor amount to provide additional extreme pressure, anti-wear and anti-oxidancy performance. Other metal salts of dithiophosphoric acids, such as copper or antimony salts are known and may be included in the lubricating oil compositions of this invention.

Other additives that may optionally be used in the lubricating oils of this invention include detergents, additional dispersants, viscosity improvers, oxidation inhibiting agents, pour point depressing agents, extreme pressure agents, anti-wear agents, color stabilizers and anti-foam agents.

Auxiliary extreme pressure agents and corrosion and oxidation inhibiting agents which may be included in the compositions of the invention are exemplified by chlorinated aliphatic hydrocarbons, organic sulfides and polysulfides, phosphorus esters including dihydrocarbon and trihydrocarbon phosphites, molybdenum compounds, and the like.

Viscosity improvers (also sometimes referred to as viscosity index improvers or viscosity modifiers) may be included in the compositions of this invention. Viscosity improvers are usually polymers, including polyisobutenes, polymethacrylic acid esters, (hydrogenated) diene polymers, polyalkyl styrenes, esterified styrene-maleic anhydride copolymers, (hydrogenated) alkenylarene-conjugated diene copolymers and polyolefins. Multifunctional viscosity improvers, other than those of the present invention, which also have dispersant and/or antioxidancy properties are known and may optionally be used in addition to the products of this invention.

Detergents are typically overbased materials. Overbased materials, otherwise referred to as overbased or superbased salts, are generally single phase, homogeneous Newtonian systems characterized by a metal content in excess of that which would be present for neutralization according to the stoichiometry of the metal and the particular acidic organic compound reacted with the metal. The overbased materials are prepared by reacting an acidic material (typically an inorganic acid or lower carboxylic acid, preferably carbon dioxide) with a mixture comprising an acidic organic compound, a reaction medium comprising at least one inert, organic solvent (e.g., mineral oil, naphtha, toluene, xylene) for said acidic organic material, a stoichiometric excess of a metal base, and a promoter such as a phenol or alcohol. The acidic organic material will normally have a sufficient number of carbon atoms to provide a degree of solubility in oil. The amount of excess metal is commonly expressed in terms of metal ratio. The term “metal ratio” is the ratio of the total equivalents of the metal to the equivalents of the acidic organic compound. A neutral metal salt has a metal ratio of one. A salt having 4.5 times as much metal as present in a normal salt will have metal excess of 3.5 equivalents, or a ratio of 4.5.

Such overbased materials are well known to those skilled in the art. Patents describing techniques for making basic salts of sulfonic acids, carboxylic acids, phenols, phosphonic acids, and mixtures of any two or more of these include U.S. Pat. Nos. 2,501,731; 2,616,905; 2,616,911; 2,616,925; 2,777,874; 3,256,186; 3,384,585; 3,365,396; 3,320,162; 3,318,809; 3,488,284; and 3,629,109.

Dispersants, other than those prepared from the condensed amines described above, are well known in the field of lubricants. Another class of ashless dispersant, besides those based upon amines, is high molecular weight esters. These materials are similar to the above-described succinimides except that they may be seen as having been prepared by reaction of a hydrocarbyl acylating agent and a polyhydric aliphatic alcohol such as glycerol, pentaerythritol, or sorbitol. Such materials are described in more detail in U.S. Pat. No. 3,381,022. Other dispersants include polymeric dispersant additives, which are generally hydrocarbon-based polymers which contain polar functionality to impart dispersancy characteristics to the polymer. Any of such dispersants can also be post-treated by reaction with any of a variety of agents as described above.

The above-illustrated additives may each be present in lubricating compositions at a concentration of as little as 0.001% by weight, usually 0.01% to 20% by weight. In most instances, they each contribute 0.1% to 10% by weight, more often up to 5% by weight.

The various additives described herein can be added directly to the lubricant. In one embodiment, however, they can be diluted with a concentrate-forming amount of a substantially inert, normally liquid organic diluent such as mineral oil or a synthetic oil such as a polyalphaolefin to form an additive concentrate. These concentrates usually comprise 0.1 to 80% by weight of the compositions of this invention and may contain, in addition, one or more other additives known in the art or described hereinabove. Concentrations such as 15%, 20%, 30% or 50% of the additives or higher may be employed. By a “concentrate forming amount” is generally mean an amount of oil or other solvent less than the amount present in a fully formulated lubricant, e.g., less than 85% or 80% or 70% or 60%. Additive concentrates can be prepared by mixing together the desired components, often at elevated temperatures, usually up to 150° C. or 130° C. or 115° C.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

As used herein, the description that the condensed amine is prepared from materials “other than ethylene dichloride” and similar expressions are intended to mean that the amine is not prepared by the ethylene dichloride process. That is, the synthetic step to produce the final product of increased molecular weight does not involve ethylene chloride as a reactant. It is possible that ethylene chloride is not employed at all at any stage leading to the final amines used in the present invention. Alternatively, it is possible that ethylene chloride might be involved in an early step to provide a precursor polyamine, which is subsequently coupled by a final or near-final synthetic step which does not employ ethylene chloride.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

### Examples 1-7

Polyamines synthesized with the coupling molecules epichlorohydrin (Ia), diethylmaleate (Ib), ethylchloroacetate (Ic), and diethylmalonate (Id) are reacted with polyisobutylene succinic anhydrides to form dispersants, as indicated in Table 1, below. In this process, polyisobutylene succinic anhydrides are diluted in diluent oil and heated to 110° C. The coupled polyamine is added to the anhydride dropwise via an addition funnel. Following completion of the amine addition, the reaction mixture is heated to 155° C. to remove the water of reaction and the mixture is filtered through diatomaceous earth to give the desired dispersant product (in diluent oil) as the filtrate. Table 1 below shows the kinematic viscosity measured at 100° C. for the dispersant products made from the polyamines indicated. The dispersant made from an EDC heavy polyamine serves as a baseline for comparison versus the alternately coupled amines.

The dispersants indicated in Table 1 are blended into fully formulated lubricating oils and subjected to a bench test that assesses the sludge performance of the oil. In this test, the lubricating oil is exposed to nitric acid and iron naphthenate under a flow of NOx and air at elevated temperatures to promote sludge formation. Samples are removed at specific time intervals and spotted on chromatography paper. The spots are developed by placing the chromatography paper in a 60° C. oven for 24 hours. The spots are rated with a digital imaging system. The (diameter of the inner spot/diameter of the outer spot)×100 is reported. A result of 100% indicates that the sludge is well dispersed while a 50% spot ratio describes a spot where the sludge is not well dispersed. The number of hours it takes to achieve a 50% spot ratio is defined as the “hours to fail” in this test. An oil with a higher “hours to fail” rating is generally superior to an oil that fails more quickly.

Table 1. Kinematic viscosity and sludge screen test results of selected dispersants from coupled polyamines. Examples shown are designated, respectively as 1 (comparative), 2, 3, 4, 5, 6, and 7.

| | | Dispersant | |
|---|---|---|---|
| | | Viscosity | Sludge Results |
| Example | Amine | mm²/s (cSt) | (hours to fail) |
| 1 (ref.) | EDC heavy polyamine | 181 | 114 |
| 2 | DETA/EPI (Ia) | 238 | 114 |
| 3 | PDA/EPI (Ia) | 387 | 119 |
| 4 | DETA/DiEtMaleate (Ib) | 188 | 130 |
| 5 | TETA/DiEtMaleate (Ib) | 259 | 129 |
| 6 | TETA/Di EtMalonate (Id) | 204 | 136 |
| 7 | TETA/EtClOAc (Ic) | 226 | 141 |

A baseline dispersant made from the high molecular weight amine product formed from the EDC process gives a result of 114 hrs. A similarly prepared dispersant made using the amino alcohol product from DETA coupled with epichlorohydrin also has a result of 114 hours to fail. A dispersant made from the amide derived by reacting DETA with diethylmaleate gives a result of 130 hours to fail. This indicates that dispersants derived from the amino alcohols and amides are as good as the ethyleneamines in serving as raw materials for dispersant synthesis with regards to dispersing sludge.

### Examples 8-23

### Example 8 (Comparative)

A dispersant is prepared by dissolving 500 g of succinated polyisobutylene (2000 Mn polybutene alkylated with maleic anhydride in a modified one-step process, total acid number of product (TAN)=74.8) in 530 g diluent oil. The mixture is warmed to 110° C. and 35.9 g HPA-X polyethyleneamine bottoms is added to the preparation drop-wise subsurface over 30 min. The mixture is stirred at 110° C. for 30 min, then warmed to 155° C. for 5 hr. The product is filtered through diatomaceous earth to yield=984 g of dispersant in diluent oil, % N=1.16 (percent N by weight of the entire composition including diluent oil).

### Example 9 (Comparative)

A dispersant similar to that of Ex. 8 is prepared by dissolving 550 g of a similar succinated polyisobutylene but having TAN=68.2 in 505 g diluent oil and reacting with 24.9 g HPA-X polyethyleneamine bottoms, and further treating as in Example 8. Yield=1013 g, % N=0.79.

### Example 10

A dispersant is prepared by the method for Comparative example 8 using 285 g succinated polyisobutylene, 301.3 g diluent oil and 19.6 g of a polyamine prepared by coupling DETA with diethanolamine, available from The Dow Chemical Company, said polyamine containing about 63% hexamine and lower amines and about 35.3% heptamine or greater amines, and about 25% of the molecules containing hydroxy functionality. Yield=569 g, % N=0.98.

### Example 11

A dispersant is prepared by the method for Comparative example 8 using 285 g succinated polyisobutylene, 302.9 g diluent oil and 21.2 g of a polyamine as in Example 10. Yield=567 g, % N=1.07.

### Example 12

A dispersant is prepared by the method for Comparative example 8 using 285 g succinated polyisobutylene, 304.5 g diluent oil and 22.8 g of a polyamine as in Example 10. Yield=574 g, % N=1.19.

### Example 13

A dispersant is prepared by dissolving 285 g of succinated polyisobutylene as in Comparative Example 8 in 300.3 g diluent oil. The mixture is warmed to 110° C. and a mixture of 2.8 g DETA and 15.8 g of a polyamine prepared by coupling DETA with diethanolamine as in Example 10 is added drop-wise subsurface over 30 min. The mixture is further treated as in Example 8. Yield=564 g, % N=1.01.

### Example 14

A dispersant was prepared according to the method of example 13 using 285 g succinated polyisobutylene, 301.8 g diluent oil, 3.0 g DETA and 17.1 g of the polyamine used in example 10. Yield=571 g, % N=1.16.

### Example 15

A dispersant is prepared according to the method of example 13 using 285 g succinated polyisobutylene, 302.3 g diluent oil, 1.6 g DETA and 19.0 g of the polyamine used in example 10. Yield=572 g, % N=1.08.

### Example 16

A dispersant is prepared by dissolving 285 g of succinated polyisobutylene as in Comparative example 8 in 302.5 g diluent oil. The mixture is warmed to 110° C. and a mixture of 10.4 g E-100 polyethyleneamine bottoms and 10.4 g of a polyamine prepared by coupling DETA with diethanolamine as in Example 12 is added drop-wise subsurface over 30 min. The mixture is further treated as in Example 8. Yield=568 g, % N=1.07.

### Example 17

A dispersant is prepared according to the method of example 16 using 285 g succinated polyisobutylene, 302.8 g diluent oil, 5.3 g E-100 polyethyleneamine bottoms and 15.8 g of the polyamine used in example 10. Yield=565 g, % N=1.05.

### Example 18

A dispersant is prepared by the method for Comparative example 9 using 300 g succinated polyisobutylene, 275.4 g diluent oil and 13.3 g of the polyamine used in example 10. Yield=523 g, % N=0.68.

### Example 19

A dispersant was prepared by the method for Comparative example 9 using 300 g succinated polyisobutylene, 276.1 g diluent oil and 14.4 g of the polyamine used in example 10. Yield=524 g, % N=0.72.

### Example 20

A dispersant is prepared by the method for Comparative example 9 using 300 g succinated polyisobutylene, 277.3 g diluent oil and 16.0 g of the polyamine used in example 10. Yield=545 g, % N=0.81.

### Example 21

A dispersant is prepared by dissolving 300 g of succinated polyisobutylene as in Example 9 in 275.8 g diluent oil. The mixture is warmed to 110° C. and a mixture of 1.1 g DETA and 12.9 g of the polyamine used in example 10 was added and reacted according to the procedure of Example 8. Yield=538 g, % N=0.72.

### Example 22

A dispersant is prepared by dissolving 300 g of succinated polyisobutylene as in Example 9 in 276 g diluent oil. The mixture is warmed to 110° C. and a mixture of 7.1 g E-100 polyethyleneamine bottoms and 7.1 g of the polyamine prepared by coupling DETA with diethanolamine is added and reacted as in Example 8. Yield=534 g, % N=0.79.

### Example 23

A dispersant is prepared according to the method of example 22 using 300 g succinated polyisobutylene, 276.1 g diluent oil, 3.6 g E-100 polyethyleneamine bottoms and 10.7 g of the polyamine used in example 10. Yield=532 g, % N=0.77.

The above dispersant compositions are analyzed for 100° C. kinematic viscosity by ASTM Procedure D445_{—}100. The results are shown below in Tables 2 and 3. It is generally understood that dispersants having higher % N content are suitable for lubricants for heavy duty diesel engines (“HD”) and dispersants having lower % N content are suitable for lubricants for passenger car motor oils (“PCMO”)

TABLE 2
HD-type Dispersant Viscosities.

| Dispersant | D445_100 Visc. mm²/sec (cSt) |
|---|---|
| Comp. Example 8 | 183 |
| Example 10 | 369 |
| Example 11 | 312 |
| Example 12 | 263 |
| Example 13 | 220 |
| Example 14 | 187 |
| Example 15 | 232 |
| Example 16 | 239 |
| Example 17 | 272 |

TABLE 3
PCMO-type Dispersant Viscosities.

| Dispersant | D445_100 Visc. mm²/sec (cSt) |
|---|---|
| Comp. Example 9 | 548 |
| Example 18 | 711 |
| Example 19 | 703 |
| Example 20 | 649 |
| Example 21 | 588 |
| Example 22 | 606 |
| Example 23 | 685 |

The invention thus imparts superior viscometrics to succinimide dispersants.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

1. A dispersant comprising the condensation product of a hydrocarbyl-substituted moiety capable of condensing with an amine, said amine comprising a coupled polyamine which is the coupled product of an alkylene polyamine with a reactive difunctional molecule selected from the group consisting of epihalohydrins, α-halogenated acids or esters, and malonates.

2. The dispersant of claim 1 wherein the alkylene polyamine is selected from the group consisting of ethylenediamine, diethylenetriamine, triethylenetetramine, propylenediamine, and mixtures thereof.

3-4. (canceled)

5. The dispersant of claim 1 wherein the dispersant is a succinimide dispersant.

6. The dispersant of claim 1 wherein the dispersant is a Mannich dispersant.

7. The dispersant of claim 1 wherein the dispersant is a polymeric dispersant.

8. The dispersant of claim 1 wherein the dispersant has been post treated with one or more of urea, thiourea, dimercaptothiadiazoles, carbon disulfide, aldehydes, ketones, carboxylic acids, hydrocarbon-substituted succinic anhydrides, nitriles, epoxides, alkaline earth metal salts, boron compounds, and phosphorus compounds.

9. The dispersant of claim 1 wherein the amine condensed with the hydrocarbyl-substituted moiety further comprises an amine other than the coupled polyamine.

10. The dispersant of claim 9 wherein the amine other than the coupled polyamine comprises ethylenediamine, diethylenetriamine, triethylenetetramine, tetraethylenepentamine or ethylenepolyamine bottoms.

11. A lubricant composition comprising an oil of lubricating viscosity and an amount of the dispersant of claim 1 suitable to provide dispersancy properties thereto.

12. The lubricant composition of claim 11 further comprising at least one of detergents, additional dispersants, viscosity improvers, oxidation inhibiting agents, pour point depressing agents, extreme pressure agents, anti-wear agents, color stabilizers, and anti-foam agents.

13. A method for preparing a dispersant, comprising reacting a hydrocarbyl-substituted succinic anhydride with an amine, said amine comprising a coupled polyamine which is the coupled product of an alkylene polyamine with a reactive difunctional molecule selected from the group consisting of epihalohydrins, α-halogenated acid or esters, and malonates, under condensing conditions.

14. The dispersant of claim 1 wherein the reactive difunctional material is an epihalohydrin.

15. The dispersant of claim 3 wherein the epihalohydrin is epichlorohydrin and the condensation product is reacted with a boron compound.
